(19) United States
(12) Patent Application Publication
(10) Pub. No.: US 2025/0254557 A1
(43) Pub. Date: Aug. 7, 2025

(54) Method And Apparatus For Event Triggered Layer 1 Measurement Reporting In Mobile Communications

(71) Applicant: MediaTek Singapore Pte. Ltd., Singapore (SG)

(72) Inventors: Xiaonan Zhang, Beijing (CN); Yuanyuan Zhang, Beijing (CN)

(21) Appl. No.: 19/034,565

(22) Filed: Jan. 23, 2025

(30) Foreign Application Priority Data
Feb. 1, 2024 (WO) PCT/CN2024/075311
Jan. 14, 2025 (CN) 202510056191.1

(51) Int. Cl. H04W 24/10

(52) U.S. Cl. CPC H04W 24/10

(57) ABSTRACT

Various solutions for event triggered L1 measurement reporting with respect to user equipment (UE) in mobile communications are described. A UE may perform layer 1 (L1) measurement. Also, the UE may start a timer in an event that a predetermined event occurs. Further, the UE may transmit an L1 measurement report to a network node in an event that the timer expires. By utilizing such timer, the event triggered L1 measurement reporting can be performed timely so that the signaling overhead can be reduced.

### CROSS REFERENCE TO RELATED PATENT APPLICATION(S)

The present disclosure is part of a non-provisional application claiming the priority benefit of PCT Application No. PCT/CN2024/075311, filed 1 Feb. 2024, and CN application Ser. No. 20/251,0056191.1, filed 14 Jan. 2025. The contents of aforementioned applications are herein incorporated by reference in their entirety.

### TECHNICAL FIELD

The present disclosure is generally related to mobile communications and, more particularly, to event triggered layer 1 measurement reporting with respect to user equipment in mobile communications.

### BACKGROUND

Unless otherwise indicated herein, approaches described in this section are not prior art to the claims listed below and are not admitted as prior art by inclusion in this section.

In mobile communications, handover refers a process of transferring an ongoing communication session of a user equipment (UE) from one cell to another in connected state, such that seamless connectivity and continuity of service for the user can be ensured, especially when the user is on the move. In legacy handover (e.g., a type of cell switch) specified in 3^{rd} Generation Partnership Project (3GPP) Release 17, a serving cell switch is triggered by layer 3 (L3) measurements with radio resource control (RRC) signaling for switching from a serving cell to a target cell. This L3 based mobility involves reconfiguration of upper layers (e.g., RRC layer and/or packet data convergence protocol (PDCP) layer) and resetting of lower layers (e.g., medium access control (MAC) layer and/or physical (PHY) layer), which inevitably leads to long latency, large signaling overhead, and long interruption time. Advanced to Release 18, a lower layer triggered mobility (also called layer 1 (L1)/layer 2 (L2) triggered mobility, LTM) is introduced to enable the cell switch procedure via L1 or L2 signaling, which can keep configuration of the upper layers and/or minimize changes of configuration of the lower layers for reducing latency during the cell switch procedure.

In an LTM procedure, LTM preparation and early synchronization are performed prior to LTM cell switch execution. When RRC reconfiguration is applicable during LTM preparation, the UE performs L1 measurements on the configured candidate cells and transmits L1 measurement reports to the gNodeB (gNB). The transmission of L1 measurement reports via uplink control information (UCI) can occur periodically, semi-persistently, or aperiodically. However, frequent L1 measurement reporting can lead to significant signaling overhead. Also, the UCI has a rather fixed format so that the information in the L1 measurement report is limited. Therefore, there is a need to provide solutions that can achieve timely reporting while minimizing signaling overhead and maintaining data diversity in the L1 measurement report.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to event triggered layer 1 (L1) measurement reporting with respect to user equipment (UE) in mobile communications.

In one aspect, a method may involve an apparatus performing L1 measurement. The method may also involve the apparatus starting a timer in an event that a predetermined event occurs. The method may further involve the apparatus transmitting an L1 measurement report to a network node in an event that the timer expires.

In one aspect, an apparatus may comprise a transceiver which, during operation, wirelessly communicates with a network. The apparatus may also comprise a processor communicatively coupled to the transceiver. The processor, during operation, may perform operations comprising performing L1 measurement. The processor may also perform operations comprising starting a timer in an event that a predetermined event occurs. The processor may further perform operations comprising transmitting, via the transceiver, an L1 measurement report to a network node in an event that the timer expires.

It is noteworthy that, although description provided herein may be in the context of certain radio access technologies, networks and network topologies such as LTE, LTE-Advanced, LTE-Advanced Pro, 5G, NR, 5G-Advanced, Internet-of-Things (IoT), Narrow Band Internet of Things (NB-IoT), Industrial Internet of Things (IIoT), beyond 5G (B5G), and 6 th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with implementations of the present disclosure.

FIG. 2 is a diagram depicting an example scenario of event triggered L1 measurement reporting in accordance with implementations of the present disclosure.

FIG. 3 is a diagram depicting an example scenario of MAC layer modules of UE in accordance with an implementation of the present disclosure.

FIG. 4 is a diagram depicting another example scenario of MAC layer modules of UE in accordance with an implementation of the present disclosure.

FIG. 5 is a block diagram of an example communication system in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to event triggered layer 1 (L1) measurement reporting in mobile communications. According to the present disclosure, a number of possible solutions may be implemented separately or jointly. That is, although these possible solutions may be described below separately, two or more of these possible solutions may be implemented in one combination or another.

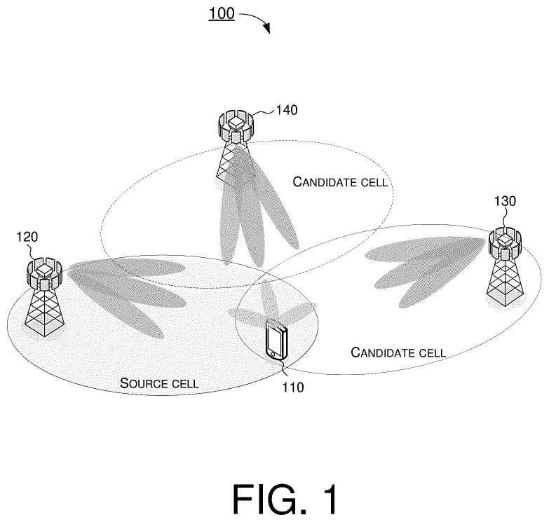

FIG. 1 illustrates an example scenario 100 of a communication environment in which various solutions and schemes in accordance with implementations of the present disclosure. Scenario 100 involves a UE 110 in wireless communication with one or more network nodes 120, 130, and 140 (e.g., a base station (BS) such as an evolved Node-B (eNB), a Next Generation Node-B (gNB), a transmission/reception point (TRP), or a radio unit (RU)). The network node 120 forms a serving cell for the UE 110 (i.e., establishes a connection with the UE 110), which is also called a source cell in terms of potential cell change due to UE mobility. In addition, there may be multiple neighboring cells around the source cell, including the cells formed by the network nodes 130 and 140, which are also called candidate cells that the UE 110 may perform L1 measurements and switch to during an L1/layer 2 (L2) triggered mobility (also called lower layer triggered mobility, LTM) procedure. The UE 110 is in the overlapping service area of the network nodes 120 and 130 and may switch back and forth between the network nodes 120 and 130 during an LTM procedure. Although not shown, the network nodes 120, 130, and 140 may be coupled to a controller forming a radio access network (RAN) that is coupled to one or more core networks, through a network entity, such as a mobility management entity (MME) or a serving gateway (SGW) in 4G LTE, or an access and mobility management function (AMF) or a user plane function (UPF) in 5G NR. In such communication environment, the UE 110 may implement various schemes pertaining to event triggered layer 1 measurement reporting in accordance with the present disclosure, as described below.

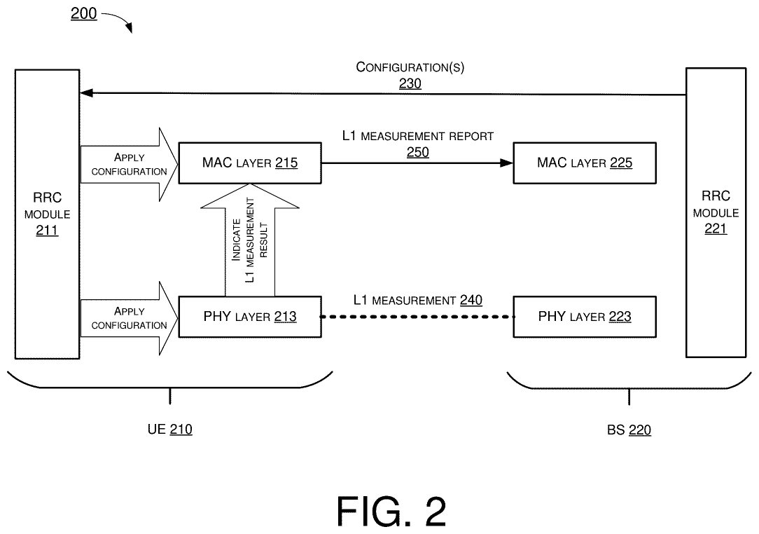

FIG. 2 is a diagram depicting an example scenario of event triggered L1 measurement reporting in accordance with implementations of the present disclosure. In scenario 200, a user equipment (UE) 210 may receive at least one configuration 230 associated with an L1 measurement reporting from a base station (BS) 220. For example, the configuration 230 may be included in a radio resource control (RRC) reconfiguration message sent by the RRC module 221 of the BS 220 to the RRC module 211 of the UE 210. The UE 210 may have a protocol stack including a physical layer (PHY) layer 213 and a medium access control (MAC) layer 215. The protocol stack of the UE 210 may include other layers such as a radio link control (RLC) layer, a packet data convergence protocol (PDCP) layer, a service data adaptation protocol (SDAP) layer (not shown). The UE 210 may apply the configuration 230 to the PHY layer 213 and the MAC layer 215 and start an event triggered L1 measurement reporting process. To be specific, the PHY layer 213 may perform an L1 measurement 240 of beam-level information such as the beam quality of the BS 220. In one embodiment, the PHY layer 213 may indicate all L1 measurement results to the MAC layer 215. For example, the PHY layer 213 may indicate an instance of each L1 measurement result to the MAC layer 215. In another embodiment, the PHY layer 213 will only indicate L1 measurement results to the MAC layer 215 if they meet a predefined threshold. For example, the PHY layer 213 may indicate an instance of L1 measurement result to the MAC layer 215 only if the measured beams reach the predefined threshold.

In scenario 200, a report triggering timer is utilized during the event triggered L1 measurement reporting process. Specifically, the MAC layer 215 may start the report triggering timer in an event that a predetermined event occurs and transmit the L1 measurement report 250 to the BS 220 in an event that the report triggering timer expires. The L1 measurement report 250 may include one or a combination of a number of L1 measurement results (e.g., all L1 measurement results), a number of L1 measurement results meeting the predefined threshold, an identity of one or more serving cells, an identity of one or more measured cells, a sequence number of the L1 measurement report, a request for timing advance (TA) for uplink (UL) synchronization, a configuration identifier (ID) from RRC configuration, and reserved bits, however, the present disclosure is not limited thereto. It should be noted that the event triggered L1 measurement reporting process may be performed during an LTM procedure and/or a beam management procedure in a multiple-input multiple-output (MIMO) system. When the event triggered L1 measurement reporting process is performed during the LTM procedure, the L1 measurement report 250 may be used for triggering the execution of LTM cell switch. When the event triggered L1 measurement reporting process is performed during the beam management procedure, the L1 measurement report 250 may be used for the MIMO beam quality reporting.

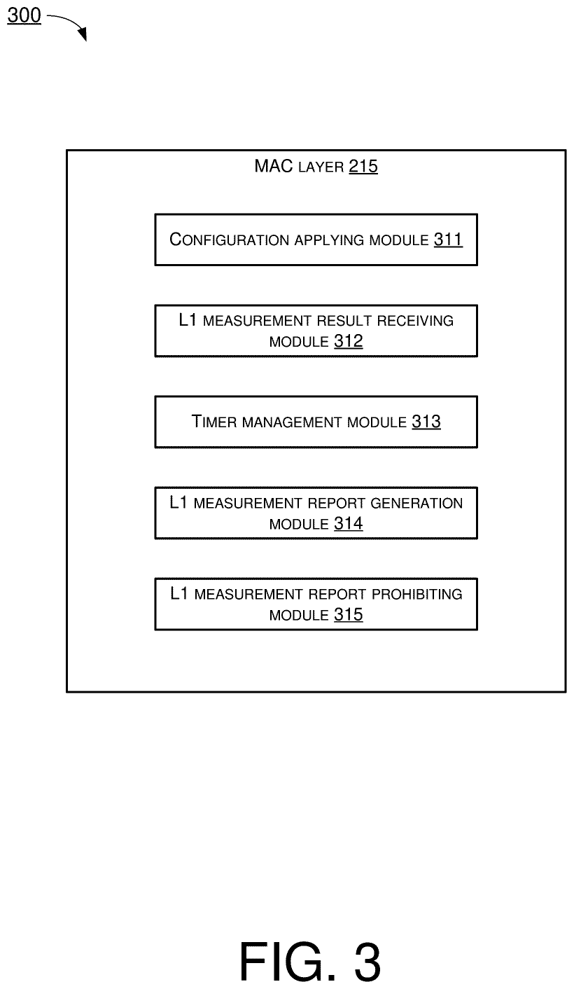

FIG. 3 is a diagram depicting an example scenario of MAC layer modules in UE in accordance with an implementation of the present disclosure. In scenario 300, the MAC layer 215 includes a configuration applying module 311, an L1 measurement result receiving module 312, a timer management module 313, an L1 measurement report generation module 314, and an L1 measurement report prohibiting module 315. The configuration applying module 311 receives and applies the configuration from the RRC layer, including different parameter settings for the thresholds, timer and flags as described below. The L1 measurement result receiving module 312 receives the instance of L1 measurement result reported by the PHY layer 213. In one embodiment, every L1 measurement result is reported by the PHY layer 213 to the MAC layer 215 for the subsequent operations of the event triggered L1 measurement reporting process. In another embodiment, only the L1 measurement result that meets the predefined threshold is reported by the PHY layer 213 to the MAC layer 215.

The timer management module 313 manages a report triggering timer for triggering the L1 measurement report 250 when a specific condition is satisfied. In one embodiment, the timer management module 313 starts the report triggering timer upon a predetermined event occurs. When the report triggering timer expires, the L1 measurement report generation module 314 generates and transmits the L1 measurement report 250 to the BS 220. It should be noted that the timer management module 313 may stop the report triggering timer in an event that a timer stopping condition is satisfied. The timer stopping condition may include one or a combination of not receiving any L1 measurement result for a first predetermined time period, receiving an L1 measurement result lower than a threshold, and receiving at least two consecutive L1 measurement results lower than the threshold. For example, after the timer management module 313 starts the report triggering timer, the L1 measurement result receiving module 312 continues receiving the L1 measurement result from the PHY layer 213. Upon receiving an indication of several consecutive L1 measurement results below the threshold, the timer management module 313 stops the report triggering timer.

The L1 measurement report prohibiting module 315 may control a report prohibited timer to prevent the UE 210 from transmitting multiple L1 measurement reports within a predetermined time period. For example, after the L1 measurement report generation module 314 transmits the first L1 measurement report, the L1 measurement report prohibiting module 315 starts the report prohibit timer. According to one embodiment, the report prohibit timer starts counting down from a predefined value, and the report prohibit timer stops running when the timer value reaches 0. According to another embodiment, the report prohibit timer starts counting from 0, and the report prohibit timer stops running when the timer value reaches a predefined value. After that, the L1 measurement report generation module 314 can transmit another L1 measurement report only if the report prohibit timer is not running. By utilizing the report prohibited timer, transmitting multiple L1 measurement reports in a short time can be avoided.

In scenario 300, the L1 measurement report 250 may be carried/delivered by an L1 measurement report medium access control (MAC) control element (CE) and may be used for the LTM to trigger the execution of LTM cell switch.

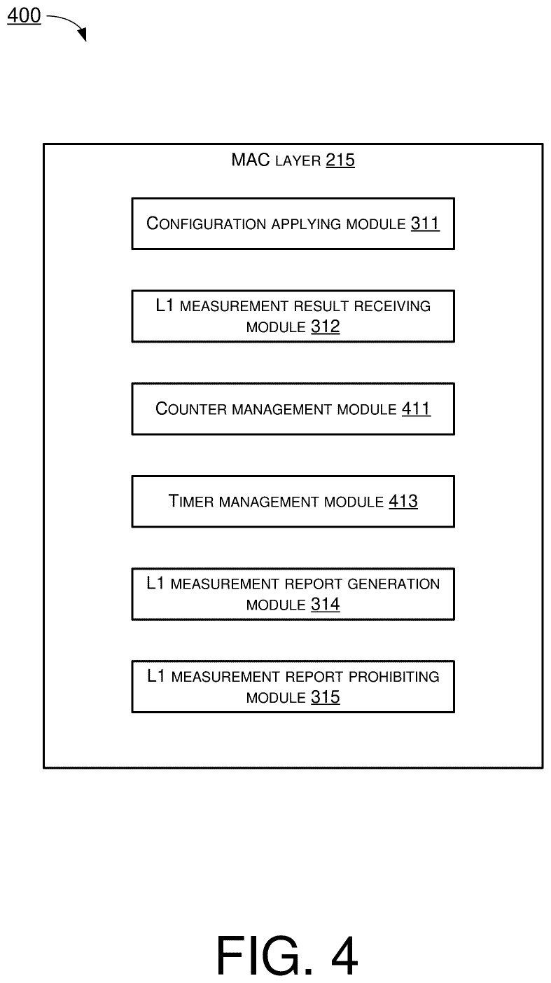

FIG. 4 shows another example scenario of MAC layer modules of UE in accordance with an implementation of the present disclosure. In scenario 400, the MAC layer 215 includes a configuration applying module 311, an L1 measurement result receiving module 312, a counter management module 411, a timer management module 413, an L1 measurement report generation module 314, and an L1 measurement report prohibiting module 315. The functionalities of the configuration applying module 311, the L1 measurement result receiving module 312, the L1 measurement report generation module 314, and the L1 measurement report prohibiting module 315 may be similar or identical to the corresponding modules in scenario 300, therefore the details are omitted here.

In scenario 400, not only a report triggering timer but also a specific counter is utilized in the event triggered L1 measurement reporting process, the counter and the report triggering timer are controlled by the counter management module 411 and the timer management module 413, respectively. The counter management module 411 manages the counter in response to obtaining at least one L1 measurement result. Specifically, when the L1 measurement result receiving module 312 receives the L1 measurement result reported by the PHY layer 213 and if the counter has not been initialized, the counter management module 411 may initialize the counter and set its value to 0. On the other hand, when the counter has been initialized, the counter management module 411 may increase the counter upon receiving an L1 measurement result from the PHY layer 213. Besides, the counter management module 411 may reset the counter upon receiving an L1 measurement result not meeting a predefined threshold.

In one embodiment, the timer management module 413 may start the report triggering timer in an event that the counter reaches a predefined value, and the L1 measurement report generation module 314 may generate and transmit the L1 measurement report 250 to the BS 220 upon the report triggering timer expires. For example, if the predefined value is 0, then the report triggering timer is started after receiving the first L1 measurement result. If the predefined value is 2, then the report triggering timer is started after receiving the third L1 measurement result. The predefined value may be configured by, for example, an RRC message and is applied to the MAC layer 215 by the configuration applying module 311.

In another embodiment, the timer management module 413 may start the report triggering timer upon receiving the first L1 measurement result and the counter management module 411 may initialize the counter concurrently. In this embodiment, the L1 measurement report generation module 314 may generate and transmit the L1 measurement report 250 to the BS 220 based on whether the report triggering timer expires and the counter value.

In scenario 400, the L1 measurement report 250 may be carried/delivered by an L1 measurement report MAC CE and may be used for the LTM to trigger the execution of LTM cell switch. Alternatively, the L1 measurement report 250 may be an uplink control information (UCI) report and may be used for the MIMO beam quality reporting.

By utilizing a report triggering timer, the event triggered L1 measurement reporting can be performed timely so that the signaling overhead can be reduced.

### Illustrative Implementations

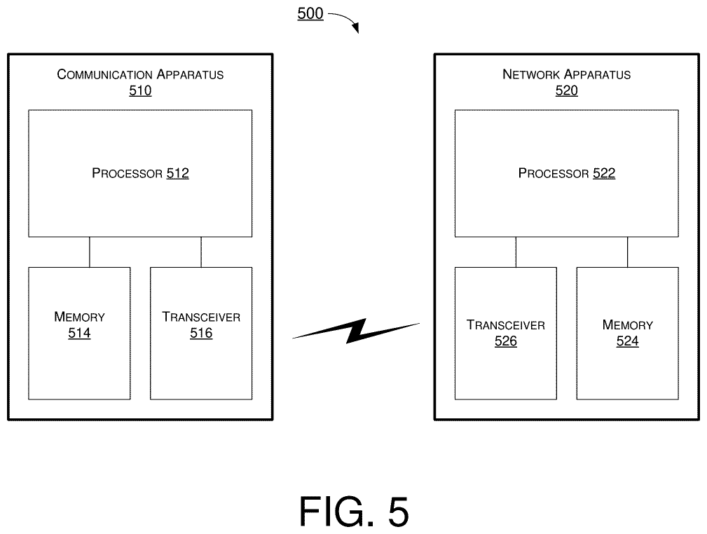

FIG. 5 illustrates an example communication system 500 having at least an example communication apparatus 510 and an example network apparatus 520 in accordance with an implementation of the present disclosure. Each of the communication apparatus 510 and network apparatus 520 may perform various functions to implement schemes, techniques, processes and methods described herein pertaining to event triggered L1 measurement reporting in mobile communications, including scenarios/schemes described above as well as process 600 described below.

Communication apparatus 510 may be a part of an electronic apparatus, which may be a UE such as a portable or mobile apparatus, a wearable apparatus, a wireless communication apparatus or a computing apparatus. For instance, communication apparatus 510 may be implemented in a smartphone, a smartwatch, a personal digital assistant, a digital camera, or a computing equipment such as a tablet computer, a laptop computer or a notebook computer. Communication apparatus 510 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 510 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of a network apparatus, which may be a network node such as a satellite, a base station, a small cell, a router or a gateway. For instance, network apparatus 520 may be implemented in an eNB in an LTE network, in a gNB in a 5G/NR, IoT, NB-IoT or IIoT network or in a satellite or base station in a 6G network. Network apparatus 520 may include at least some of those components shown in FIG. 5 such as a processor 522, for example. Processor 522 may further include protocol stacks and a set of control functional modules and circuits. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of the processor 512 and processor 522 may be implemented in the form of one or more single-core processors, one or more multi-core processors, or one or more CISC processors. That is, even though a singular term “a processor” is used herein to refer to processor 512 and processor 522, each of the processor 512 and processor 522 may include multiple processors in some implementations and a single processor in other implementations in accordance with the present disclosure. In another aspect, each of the processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 512 and processor 522 is a special-purpose machine specifically designed, arranged and configured to perform specific tasks in a device (e.g., as represented by communication apparatus 510) and a network (e.g., as represented by network apparatus 520) in accordance with various implementations of the present disclosure.

In some implementations, communication apparatus 510 may also include a transceiver 516 coupled to processor 512 and capable of wirelessly transmitting and receiving data. In some implementations, communication apparatus 510 may further include a memory 514 coupled to processor 512 and capable of being accessed by processor 512 and storing data therein.

In some implementations, network apparatus 520 may include a transceiver 526 coupled to processor 522 and capable of wirelessly transmitting and receiving data. In some implementations, network apparatus 520 may further include a memory 524 coupled to processor 522 and capable of being accessed by processor 522 and storing data therein. Accordingly, communication apparatus 510 and network apparatus 520 may wirelessly communicate with each other via transceiver 516 and transceiver 526, respectively.

For illustrative purposes and without limitation, descriptions of capabilities of the communication apparatus 510 and network apparatus 520 are provided below with process 600. In which, communication apparatus 510 is implemented in or as a communication apparatus or a UE, and network apparatus 520 is implemented in or as a network node of a communication network (e.g., a base station).

### Illustrative Processes

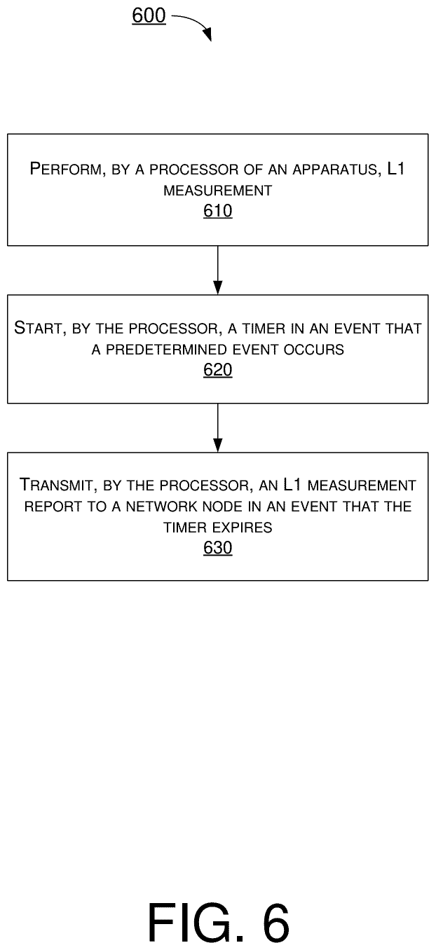

FIG. 6 illustrates an example process 600 in accordance with an implementation of the present disclosure. Process 600 may be an example implementation of above scenarios/schemes, whether partially or completely, with respect to event triggered L1 measurement reporting in mobile communications. Process 600 may represent an aspect of implementation of features of communication apparatus 510. Process 600 may include one or more operations, actions, or functions as illustrated by one or more of blocks 610, 620, and 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by communication apparatus 510 or any suitable UE or machine type devices. Solely for illustrative purposes and without limitation, process 600 is described below in the context of communication apparatus 510 as a UE. Process 600 may begin at block 610.

At block 610, process 600 may involve processor 512 of communication apparatus 510 performing L1 measurement. Process 600 may proceed from block 610 to block 620.

At block 620, process 600 may involve processor 512 starting a timer in an event that a predetermined event occurs. Process 600 may proceed from block 620 to block 630.

At block 630, process 600 may involve processor 512 transmitting, via transceiver 516, an L1 measurement report to a network node (e.g., network apparatus 520) in an event that the timer expires.

In some implementations, process 600 may further involve processor 512 receiving, via transceiver 516, a configuration associated with an L1 measurement reporting. Also, process 600 may involve processor 512 applying the configuration to a PHY layer and a MAC layer of communication apparatus 510.

In some implementations, at least one L1 measurement result meeting a predefined threshold is indicated by the PHY layer to the MAC layer.

In some implementations, all L1 measurement results are indicated by the PHY layer to the MAC layer.

In some implementations, process 600 may further involve processor 512 stopping the timer in an event that a timer stopping condition is satisfied.

In some implementations, the timer stopping condition may include not receiving any L1 measurement result for a first predetermined time period, receiving an L1 measurement result lower than a threshold, or receiving at least two consecutive L1 measurement results lower than the threshold.

In some implementations, process 600 may further involve processor 512 prohibiting a transmission of multiple L1 measurement reports within a second predetermined time period.

In some implementations, process 600 may further involve processor 512 managing a counter in response to obtaining at least one L1 measurement result.

In some implementations, the timer is started in an event that the counter reaches a predefined value.

In some implementations, the L1 measurement report may be carried/delivered by an L1 measurement report MAC CE.

In some implementations, the L1 measurement report may include one or a combination of a number of L1 measurement results, an identity of a serving cell, an identity of a measured cell, a sequence number of the L1 measurement report, a request for TA for UL synchronization, and a configuration ID from RRC configuration.

In some implementations, the L1 measurement report may be used for the LTM or the MIMO beam quality reporting.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
performing, by a processor of an apparatus, layer 1 (L1 ) measurement;
starting, by the processor, a timer in an event that a predetermined event occurs; and
transmitting, by the processor, an L1 measurement report to a network node in an event that the timer expires.

2. The method of claim 1, further comprising:
receiving, by the processor, a configuration associated with an L1 measurement reporting; and
applying, by the processor, the configuration to a physical (PHY) layer and a medium access control (MAC) layer of the apparatus.

3. The method of claim 2, wherein at least one L1 measurement result meeting a predefined threshold is indicated by the PHY layer to the MAC layer.

4. The method of claim 2, wherein all L1 measurement results are indicated by the PHY layer to the MAC layer.

5. The method of claim 1, further comprising:
stopping, by the processor, the timer in an event that a timer stopping condition is satisfied.

6. The method of claim 5, wherein the timer stopping condition comprises:
not receiving any L1 measurement result for a first predetermined time period,
receiving an L1 measurement result lower than a threshold, or
receiving at least two consecutive L1 measurement results lower than the threshold.

7. The method of claim 1, further comprising:
prohibiting, by the processor, a transmission of multiple L1 measurement reports within a second predetermined time period.

8. The method of claim 1, further comprising:
managing, by the processor, a counter in response to obtaining at least one L1 measurement result.

9. The method of claim 8, wherein the timer is started in an event that the counter reaches a predefined value.

10. The method of claim 1, wherein the L1 measurement report is carried by an L1 measurement report medium access control (MAC) control element (CE).

11. The method of claim 1, wherein the L1 measurement report comprises one or a combination of a number of L1 measurement results, an identity of a serving cell, an identity of a measured cell, a sequence number of the L1 measurement report, a request for timing advance (TA) for uplink (UL) synchronization, and a configuration identifier (ID) from radio resource control (RRC) configuration.

12. The method of claim 1, wherein the L1 measurement report is used for an L1 /layer 2 (L2) triggered mobility (LTM) or a multiple-input multiple-output (MIMO) beam quality reporting.

13. An apparatus, comprising:
a transceiver which, during operation, communicates wirelessly; and
a processor communicatively coupled to the transceiver such that, during operation, the processor performs operations comprising:
performing layer 1 (L1 ) measurement;
starting a timer in an event that a predetermined event occurs; and
transmitting, via the transceiver, an L1 measurement report to a network node in an event that the timer expires.

14. The apparatus of claim 13, wherein, during operation, the processor further performs operations comprising:
receiving, via the transceiver, a configuration associated with an L1 measurement reporting; and
applying the configuration to a physical (PHY) layer and a medium access control (MAC) layer of the apparatus.

15. The apparatus of claim 14, wherein:
at least one L1 measurement result meeting a predefined threshold is indicated by the PHY layer to the MAC layer, or all L1 measurement results are indicated by the PHY layer to the MAC layer.

16. The apparatus of claim 13, wherein, during operation, the processor further performs operations comprising:
stopping the timer in an event that a timer stopping condition is satisfied.

17. The apparatus of claim 16, wherein the timer stopping condition comprises:
not receiving any L1 measurement result for a first predetermined time period,
receiving an L1 measurement result lower than a threshold, or
receiving at least two consecutive L1 measurement results lower than the threshold.

18. The apparatus of claim 13, wherein, during operation, the processor further performs operations comprising:
prohibiting a transmission of multiple L1 measurement reports within a second predetermined time period.

19. The apparatus of claim 13, wherein, during operation, the processor further performs operations comprising:
managing a counter in response to obtaining at least one L1 measurement result,
wherein the timer is started in an event that the counter reaches a predefined value.

20. The apparatus of claim 13, wherein:
the L1 measurement report is carried by an L1 measurement report medium access control (MAC) control element (CE),
the L1 measurement report comprises one or a combination of a number of L1 measurement results, an identity of a serving cell, an identity of a measured cell, a sequence number of the L1 measurement report, a request for timing advance (TA) for uplink (UL) synchronization, and a configuration identifier (ID) from radio resource control (RRC) configuration, or
the L1 measurement report is used for an L1 /layer 2 (L2) triggered mobility (LTM) or a multiple-input multiple-output (MIMO) beam quality reporting.
